(19) United States
(12) Patent Application Publication
(10) Pub. No.: US 2022/0048512 A1
(43) Pub. Date: Feb. 17, 2022

(54) DATA MEMORY, COMPUTER UNIT AND METHOD FOR EXECUTING A FUNCTION OF A VEHICLE

(71) Applicant: Continental Automotive GmbH, Hannover (DE)

(72) Inventor: Andreas Heinrich, Laaber (DE)

(73) Assignee: Continental Automotive GmbH, Hannover (DE)

(21) Appl. No.: 17/309,824

(22) PCT Filed: Dec. 19, 2019
(86) PCT No.: PCT/EP2019/086452

§ 371 Date: Jun. 21, 2021

(30) Foreign Application Priority Data
Dec. 20, 2018 (DE) 10 2018 222 410.2
Mar. 19, 2019 (DE) 10 2019 203 739.9

(51) Int. Cl. B60W 30/18; G06F 3/06; G08G 1/09; B60W 40/04

(52) U.S. Cl. CPC B60W 30/18154; G06F 3/0655; G06F 3/0604; B60W 2530/00; G08G 1/091; B60W 40/04; B60W 2520/00; G06F 3/0673

(57) ABSTRACT

A data memory, a computing unit and a method for performing a function of a vehicle are described, wherein values of an item of information relating to predefined local areas of a digital map are taken into account when the function is performed, the values of the information being stored in the form of an expected value and a distribution of the values around the expected value.

### CROSS-REFERENCE TO RELATED APPLICATIONS

This U.S. patent application claims the benefit of PCT patent application No. PCT/EP2019/086452, filed Dec. 19, 2019, which claims the benefit of German patent application No. 102018222410.2, filed Dec. 20, 2018, and German patent application No. 102019203739.9, filed Mar. 19, 2019, all of which are hereby incorporated by reference.

### TECHNICAL FIELD

The invention relates to a data memory, a computing unit and a method for performing a function of a vehicle.

### BACKGROUND

In the prior art, it is known practice for information from a digital map to be taken into account when a function of a computing unit of a vehicle is performed.

The object of the invention is to provide an improved data memory, an improved computing unit and an improved method for performing a function of a vehicle.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A data memory for a computing unit is proposed, wherein the data memory stores multiple values of an item of information for each of predefined local areas of a digital map. The values of the information are provided in order to be taken into account by the computing unit when a function is performed. The values of the information are stored in the form of an expected value and in the form of a distribution of the values around the expected value.

In this way it is not necessary for all the individual values to be stored; instead, it is sufficient to store the expected value and to store the distribution of the values around the expected value. This allows storage space to be saved. In addition, it saves transmission capacity during a data interchange, for example when storing the values of the information or when reading the values of the information. In addition, storage and reading are shortened as a result of the reduction in the data. The data memory can, for example, be integrated in a computing unit of a vehicle or can be present in the vehicle and can be connected to a computing unit of the vehicle. In addition, depending on the chosen embodiment, the data memory can also be arranged in a stationary manner as an external data memory outside the vehicle.

A local area of a digital map can contain, for example, a predefined area of the digital map or a section of at least one road or at least one geographical point on a road.

Information can be, for example, a parameter of a movement of vehicles on a road or a parameter of an operating function of vehicles, for example an energy consumption of vehicles in a local area. For example, information can be a velocity of vehicles, a positive or negative acceleration of vehicles and/or an energy consumption of vehicles in the local area.

For example, a multiplicity of values of velocities can be assigned to a local area of the digital map for the velocity of vehicles information. The values of the velocities are the values of the velocity information. In addition, multiple values for negative and positive accelerations of vehicles can be assigned to a local area of the digital map for the negative or positive acceleration of vehicles information. Furthermore, multiple values for energy consumptions of vehicles can be assigned to a local area of the digital map for the energy consumption of vehicles information. Values of information for at least one vehicle can therefore be stored and kept ready in a simple manner and with little data outlay.

For example, the values of the information from vehicles that have used the roads can be ascertained. The values of the information are therefore statistical empirical values. The values of the information can be recorded and provided by the vehicles themselves or measured and/or estimated by external measuring devices. Values for parameters of the movement of the vehicles or values for parameters of an operating function of a vehicle, for example an energy consumption, can therefore be collected according to the local positions of the vehicles on the roads and stored as values of information in a digital map in a location-based manner in relation to local areas of the digital map. In these examples, a parameter of a movement of the vehicle or a parameter of an operating state of a vehicle is information.

The computing unit can, for example, be in the form of a computing unit of a vehicle, in particular in the form of a control unit of a vehicle. One function of the vehicle includes, for example, driver information for the purpose of outputting information to a driver of the vehicle about a route being used. In addition, a function of a vehicle can include a function for longitudinal guidance and/or transverse guidance of a vehicle. For example, the function of the vehicle can include a control function of an at least semiautonomously driven vehicle. For example, the function can be a steering function, braking function or an acceleration function of the vehicle.

In the case of the proposed data memory, instead of a multiplicity of values for information, a defined value, that is to say an expected value of the information and a distribution of the values around the expected value, are stored. The distribution of the values can be specified in the form of a distribution curve or in the form of a distribution rule. This allows a multiplicity of values for information having an expected value and a distribution of the values to be stored in the data memory with little memory outlay.

In one embodiment, the distribution of the values around the expected value that is used can be a normal distribution with a standard deviation. A sufficiently precise description of the size of the values of the information can thus be stored for a plurality of values of an item of information.

In a further embodiment, the expected value provided is an expected value range and/or the distribution of the values provided is a distribution range, in particular a variance. This allows a further simplification of the stored data to be achieved.

In a further embodiment, the information is a parameter of a traffic controller. For example, a duration of a red phase, a duration of a green phase and/or a duration of an amber phase can be assigned as parameters of a traffic controller to a local area of a digital map, in particular to a local area of a digital map in front of a position of a set of traffic lights on the digital map.

For example, data that were measured using vehicles passing through the traffic light can be taken as a basis for recording the durations of a red phase, a green phase and/or an amber phase, depending on the distance to the traffic light, and assigning said phases to an applicable local position on the digital road of the digital map according to the local position of the vehicles on the real road. This information can be taken into account, for example, for driver information, route planning and/or for a function for at least semiautonomous driving of a vehicle.

A computing unit for a vehicle is proposed, which is designed to take into account values of information from the data memory when executing a function of the vehicle. The function can include a driver information function, route planning and/or a control function of the vehicle. The control function can be, for example, longitudinal guidance and/or transverse guidance of the vehicle. Longitudinal guidance is understood to mean acceleration of the vehicle or braking of the vehicle. Transverse guidance of the vehicle is understood to mean influencing the lateral direction of travel of the vehicle.

Furthermore, a method for performing a function of a vehicle is proposed, wherein values of an item of information relating to predefined local areas of a digital map are taken into account when the function is performed. The values of the information are stored in the form of an expected value and a distribution of the values of the information around the expected value.

In one embodiment, the distribution of the values is a normal distribution with a standard deviation.

In one embodiment, the computing unit is designed to carry out short-distance planning with a linear combination of the expected values and the distributions of the values of the information.

In one embodiment, the computing unit is designed to carry out long-distance planning with a Markov chain of the expected values and the distributions of the values of the information.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE FIGURES

The invention is explained in more detail below with reference to the figures, in which:

FIG. 1 shows a schematic depiction of a vehicle on a road in front of a traffic light;

FIG. 2 shows a schematic depiction of a digital map with predefined local areas;

FIG. 3 shows a schematic depiction of a normal distribution of a value with a standard deviation;

FIG. 4 shows a table containing classes of expected values;

FIG. 5 shows a schematic program sequence for carrying out a method in which a function of a vehicle is performed on the basis of values of an item of information; and

FIG. 6 shows a schematic depiction of part of a digital map containing routes with local points at which information is stored.

### DETAILED DESCRIPTION

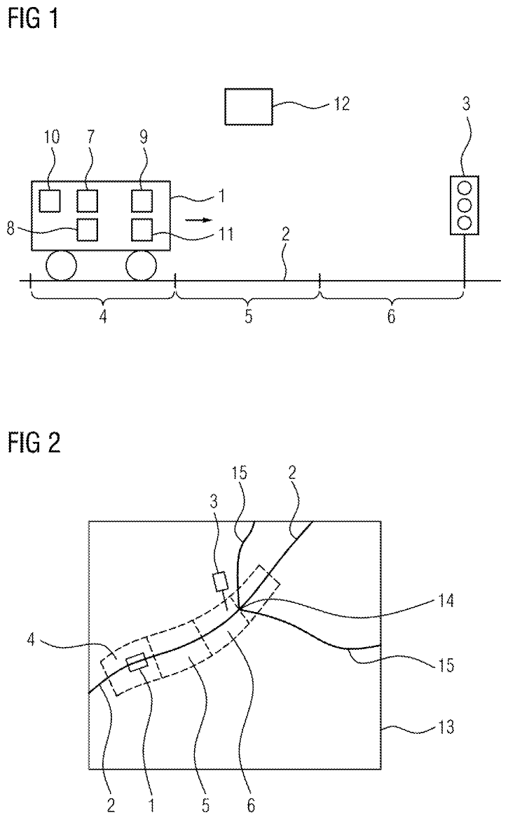

FIG. 1 shows a schematic depiction of a vehicle 1 travelling on a road 2 in the direction of a traffic light 3. The road 2 is divided into fictitious road sections 4, 5, 6. The vehicle 1 is located on the first road section 4. The second road section 5 is located in front of the vehicle 1. A third road section 6 is provided between the second road section 5 and the traffic light 3.

The vehicle 1 has a computing unit 7 and a data memory 8. The computing unit 7 and the data memory 8 are connected to one another for data interchange. Furthermore, the vehicle 1 has a locating device 9, for example in the form of a GPS system. In addition, the vehicle has an output device 10 for outputting information to a driver. Furthermore, the vehicle 1 has a controller 11 for controlling a control function of the vehicle. The control function can include, for example, longitudinal guidance of the vehicle, that is to say positive or negative acceleration. In addition, the control function can include transverse guidance of the vehicle, that is to say a steering function of the vehicle. The output device 10 can be provided in order to output information about road sections or road sections lying ahead.

Depending on the chosen embodiment, the locating device 9 can also include route planning. In addition, the route planning can also be performed by the computing unit 7.

Furthermore, there can be provision for an external data memory 12 that stores values of information relating to local areas of a digital map. Both the external data memory 12 and the data memory 8 of the vehicle 1 store values of information in the form of an expected value and a distribution of the values around the expected value. For example, the distribution of the values is in the form of a normal distribution with a standard deviation. In addition, the external data memory 12 and the data memory 8 can store the values of the information as value ranges and/or the distribution as distribution range, in particular as variance.

The information can be a parameter of a movement of a vehicle on a road or a parameter of an operating function of a vehicle, for example an energy consumption. The values of the information are values of the parameter of the movement or of the operating state of the vehicle. For example, the parameter can be a velocity, an acceleration and/or an energy consumption of at least one, in particular multiple, vehicles. A multiplicity of values are stored for each parameter.

In the exemplary embodiment depicted, each road section can have stored for it a multiplicity of velocities at which vehicles travel or have travelled on these road sections according to previous measurements. In addition, each road section can have stored for it values for accelerations of vehicles that vehicles perform or have performed on these road sections. The accelerations of the vehicles were measured beforehand. In addition, each of the road sections 4, 5, 6 can have stored for them values for energy consumptions of vehicles that vehicles have or have had on the road sections according to measurements performed. In addition, each road section can have stored for it values for durations of a red phase, a green phase and/or an amber phase that vehicles experience or have experienced, according to measurements performed, on the road sections.

As already stated, the values of the parameters for predefined local areas of a digital map, which correspond to local areas of a real map, are not stored as individual values of the information, but rather the values of an item of information are stored in the form of an expected value and in the form of a distribution of the values around the expected value. This saves storage capacity both in the data memory 8 and in the external data memory 12. In addition, transmission capacity and time are saved when the data are read and/or when the data are written from and/or to the data memory 8 or from and/or to the external data memory 12.

FIG. 2 shows a schematic depiction of a section of a digital map 13 in which the road 2 is shown. The digital map 13 is presented to the driver e.g. via an appropriate display in the vehicle. In addition, the road sections 4, 5, 6 are depicted as dashed boxes in the section 13. Furthermore, the traffic light 3 is also depicted. In addition, the vehicle 1 is depicted schematically as a box. The traffic light 3 is arranged at a junction 14 at which the road 2 crosses another road 15. The position of the vehicle 1 is recorded in the real world using the locating device 9. The real position of the vehicle 1 is assigned by the computing unit 7 to a fictitious position of the vehicle 1 on the digital map 13. The data for the digital map 13 are stored, for example, in the data memory 8 or in a further data memory, not depicted. The digital roads are divided into road sections 4, 5, 6, each road section representing a predefined local area. Instead of a road section, a local area can also comprise only one point on a road or a larger area of the map containing multiple roads. Values of information are stored for the local areas of the digital map in accordance with the data format described.

The computing unit 7 can take into account the information relating to the local areas of the digital map for performing a function of the vehicle. For example, the function can be the output of driver information via the output device 10. In addition, the performance of the function can include longitudinal guidance or transverse guidance of the vehicle. Furthermore, the performance of a function of the vehicle can include route planning for the vehicle.

Depending on the chosen embodiment, the values of the information can be received either directly from the data memory 8 and/or at least partially or completely from the external data memory 12. For this purpose, the external data memory has a transmission device. In addition, the vehicle has at least one receiving device, in particular a transmitting/receiving device.

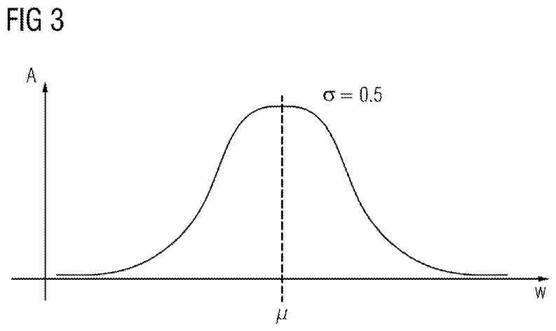

FIG. 3 shows a schematic depiction of a curve for a normal distribution of the values of an item of information.

The normal distribution is described by the following formula:

$$f ( x , μ , {σ}^{2} ) = ( \frac{1}{σ \sqrt{2 π}} ) {e}^{- \frac{1}{2} {( \frac{x - μ}{σ} )}^{2}}$$

The expected value p defines the point at which the normal distribution has its maximum. The variance σ² defines the standard deviation through the root of the variance σ. The depicted normal distribution has the value 1 for the root of the variance σ. Experiments have shown that the average of a large number of observed values for information from vehicles is approximately normally distributed and follows the central limit theorem. The values of the information can therefore be assumed to be normally distributed without great loss of accuracy and can be stored in the form of a normal distribution E (x) and σ².

In FIG. 3, the values w of the information are plotted along the horizontal axis. The number A of values is plotted along the vertical axis. A further reduction in the volume of data, in particular a volume of data to be transmitted, can be achieved by using classes of values.

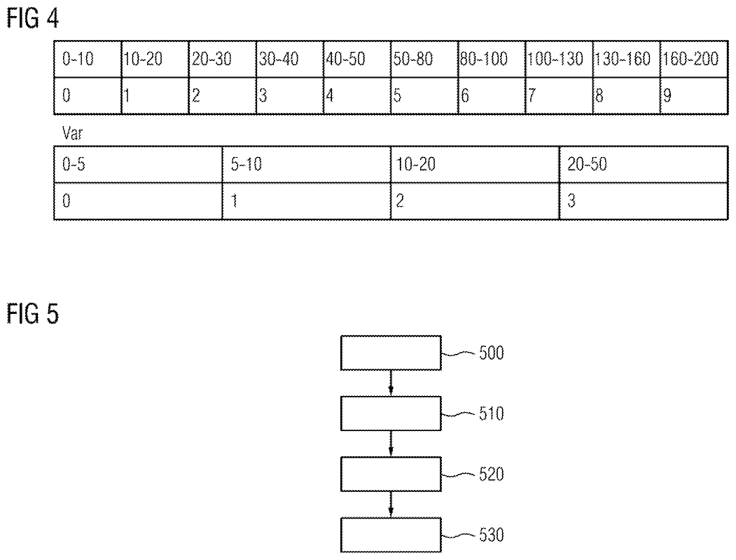

FIG. 4 shows a schematic depiction of a table, with, in the top two rows, expected values from the value 0 to the value 200 being divided into expected value ranges from 0 to 10, from 10 to 20, from 20 to 30, from 30 to 40, from 50 to 80, from 80 to 100, from 100 to 130, from 130 to 160 and from 160 to 200, that is to say into ten classes of expected values from 0 to 9. In addition, in the bottom two rows, the values for the variance of the distribution of the expectation ranges have also been divided into four value ranges, i.e. into four classes. In the example depicted, the values for the variance Var are divided into the value ranges 0 to 5, 5 to 10, 10 to 20 and 20 to 50. This results in the variance classes 0, 1, 2 and 3. If, for example, the expected value 136.765 and the variance 4.76 are stored or transmitted with this scheme, then class 8 for the expected value and class 0 for the variance are stored or transmitted instead.

FIG. 5 shows a schematic depiction of a simple program sequence for carrying out a method for performing a function of a vehicle. At program point 500, the computing unit 7 uses the locating device 9 to ascertain the real position of the vehicle 1 on a road 2. At a next program point 510, the computing unit 7 searches a digital map for a position in the digital map that corresponds to the real position of the vehicle. At a next program point 520, the computing unit 7 checks whether values of information are stored for the area in which the vehicle is located in the digital map or for the areas of the digital map in the direction of travel ahead of the vehicle. The values of the information can be stored both in the data memory 8 of the vehicle 1 and in the external data memory 12. In addition, the data memory can store an instruction that indicates what information the computing unit should take into account for what function and in particular in what way.

At a next program point 530, the computing unit performs a function of the vehicle taking into account the values of the information from the digital map.

The function can include the planning of a route from the current position to a predefined destination. In addition, the function can include acceleration or braking of the vehicle. Furthermore, the function can include a steering function of the vehicle. For example, the function can include a reduction in energy consumption on a specified road section. In addition, the function can involve passing through a traffic light 3 with the shortest possible waiting time. In addition, the function can involve outputting values of the information to the driver.

The proposed type of storage of the values of the information saves storage space and transmission capacity between the computing unit and the data memory 8 or the external data memory 12.

Due to the type of storage used, further information about the distribution of the values of the information can also be ascertained by forming quantiles and probabilities on the basis of the normal distribution. The methods described are suitable for computing units that are in the form of engine control units for vehicles.

In addition, the values of the information can be used by the computing unit for route planning. The computing unit can plan a route from a starting point to a destination, taking into account the values of the information on the digital map. For example, the computing unit can search for a route from a starting point to a destination according to a predefined criterion. The criterion can be, for example, the route with the lowest energy consumption, the shortest route or the fastest route.

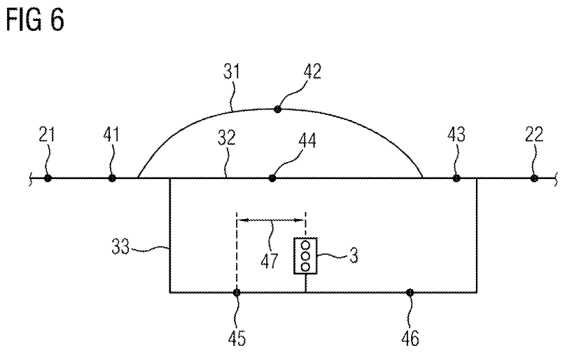

FIG. 6 shows a schematic depiction of a partial section of a digital map containing roads, which are depicted as lines. From a starting point 20 to a destination 21, three different routes 31, 32, 33 are depicted. Along the routes 31, 32, 33 there is provision on the roads in the digital map for local points 41, 42, 43, 44, 45, 46 at which values of information are stored in the form of an expected value and a distribution of the values of the information. Instead of the local points there could also be provision on the digital map for local areas to which values of information in the form of an expected value and a distribution of the values of the information are assigned. A local area can cover e.g. a predefined distance of between half a meter and several meters or up to 100 meters.

The distribution of the values can be a normal distribution with a standard deviation. The expected value provided can be an expected value range and/or the distribution provided can be a distribution range. The information can be a parameter of a movement of a vehicle or an operating parameter of a vehicle, the values of the information being the values of the parameter. The parameter can be a velocity, an acceleration and/or an energy consumption of at least one vehicle. In addition, the information can be a parameter of a traffic controller, in particular parameters of a traffic light. For example, the parameter can be a duration of a red phase, a duration of a green phase and/or a duration of an amber phase of the traffic controller of the traffic light.

Depending on the length of the route, in particular depending on the number of local points or local areas that are recorded by advance planning, the term short distance 47 or long distance can be used. In order to take into account the expected values and the distributions of the values of the local points, a linear combination of the expected values and the distributions can be carried out for a short distance 47. A short distance can comprise e.g. 2 to 5 local points or local areas and relate to e.g. a distance in front of a traffic light 3 or in front of a junction, etc. (FIG. 6).

For n normally distributed random variables

Xᵢ(i=1, . . . ,n) with Xᵢ∝(μᵢ;σᵢ²)

the linear combination

$$Y = {a}_{0} + {a}_{1} {X}_{1} + {a}_{2} {X}_{2} + … + {a}_{n} {X}_{n} = {a}_{0} + {\sum }_{i = 1}^{n} {a}_{i} {X}_{i}$$

is also normally distributed with the expected value

$$E ( Y ) = {a}_{0} + {\sum }_{i = 1}^{n} {a}_{i} E ( {X}_{i} ) = {a}_{0} + {\sum }_{i = 1}^{n} {a}_{i} {μ}_{i} .$$

If the Xᵢ (i=1, . . . , n) are stochastically independent, the following is true for the variance

$$Var ( Y ) = {\sum }_{i = □}^{n} {a}_{i}^{2} \cdot ( {X}_{i} ) = {\sum }_{i = 1}^{n} {a}_{i}^{2} {σ}_{i}^{2} .$$

The variance must be greater than zero, and therefore aⱼ≠0 must also be true for at least one j∈{1, . . . , n}.

A long distance can comprise more than 5 local points or local areas. Depending on the application, the short distance can also comprise more or fewer local points or local areas. The distance between two local points or local areas can be between 1 m and 100 m or more in the real world. In the city, the distances between the local points or local areas are shorter than outside a city.

For a long distance, the expected values and the distributions thereof are taken into account according to a Markov chain.

Formally, a Markov chain by definition has the following appearance:

P(Xₙ=s|X₀=x₀,X₁=x₁, . . . ,Xₙ₋₁=xₙ₋₁)=P(Xₙ=s|Xₙ₋₁=xₙ₋₁)

Xₙ is the random variable, while s and xₙ is the corresponding value that the random variable assumes or has assumed.

The transition probability of there being a change from state i to state j is defined as follows:

P(Xₙ₊₁=j|Xₙ=i) for all i,j∈S

So this is the sequence of values that the random variable X can assume. If these probabilities do not depend on i then the term homogeneous Markov chain is used.

Depending on the application, the computing unit can carry out advance planning for a short distance and advance planning for a long distance at parallel times. As a result, controls for the vehicle can be carried out for a short distance ahead in accordance with the advance planning for the short distance. Controls for the vehicle for a long distance are carried out by the computing unit in accordance with the advance planning for the long distance. For example, the route from a starting point to a more distant destination can be planned using the long-distance planning. In addition, while the vehicle is travelling, for example when approaching a traffic light, a velocity of the vehicle can be controlled using the short-distance planning.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

1-17. (canceled)

18. A data memory for a computing unit of a vehicle comprising:
multiple values of at least one item of information for each of predefined local areas of a digital map stored in the data memory;
wherein the values of the information are taken into account by the computing unit when a function of the vehicle is performed; and
wherein the values are stored in the form of an expected value and a distribution of the values around the expected value.

19. The data memory as claimed in claim 18, wherein the distribution of the values is a normal distribution with a standard deviation.

20. The data memory as claimed in claim 18, wherein the expected value provided is at least one of an expected value range and the distribution provided is a distribution range.

21. The data memory as claimed in claim 18, wherein the information is a parameter of a movement of a vehicle on a road, and wherein the values of the information are values of the parameter.

22. The data memory as claimed in claim 21, wherein the parameter is at least one of a velocity, an acceleration and an energy consumption of at least one vehicle.

23. The data memory as claimed in claim 18, wherein the information is a parameter of a traffic controller, in particular a traffic light.

24. The data memory as claimed in claim 23, wherein the parameter is at least one of: a duration of a red phase, a duration of a green phase and a duration of an amber phase of the traffic controller.

25. A computing unit for a vehicle for, with instructions for:
receiving multiple values of information from a data memory, wherein the multiple values are of at least one item of information for each of predefined local areas of a digital map stored in the data memory, and wherein the multiple values are stored in the form of an expected value and a distribution of values around the expected value; and
executing a function of the vehicle using the multiple values of information.

26. The computing unit as claimed in claim 25, wherein the function is a control function of the vehicle.

27. The computing unit as claimed in claim 26, wherein the control function is at least one of a longitudinal guidance and a transverse guidance of the vehicle.

28. The computing unit as claimed in claim 25, wherein the computing unit carries out short-distance planning with a linear combination of the expected values and distributions of the values of the information.

29. The computing unit as claimed in claim 25, wherein the computing unit carries out long-distance planning with a Markov chain of the expected values and distributions of the values of the information.

30. A method for performing a function of a vehicle comprising:
using multiple values of an item of information relating to predefined local areas of a digital map, and wherein the multiple values of the information are an expected value and a distribution of values around the expected value.

31. The method as claimed in claim 30, wherein the distribution of values is a normal distribution with a standard deviation.

32. The method as claimed in claim 30, wherein at least one of the expected value provided is an expected value range and the distribution provided is a distribution range.

33. The method as claimed in claim 30, wherein the information is a parameter of a movement of a vehicle on a road, and wherein the values of the information are values of the parameter.

34. The method as claimed in claim 30, wherein the parameter is at least one of: a velocity of at least one vehicle, an acceleration of at least one vehicle, an energy consumption of at least one vehicle, and a parameter of a traffic controller.

35. The method as claimed in claim 30, wherein the parameter is of the traffic controller and is at least one of: a duration of a red phase, a duration of a green phase and a duration of an amber phase of a traffic controller.
